(19) United States
(12) Patent Application Publication
(10) Pub. No.: US 2016/0240289 A1
(43) Pub. Date: Aug. 18, 2016

(54) OVERVOLTAGE ARRESTER

(71) Applicant: SIEMENS AKTIENGESELLSCHAFT, Muenchen (DE)

(72) Inventors: DANIEL FLOHE, BERLIN (DE); ANDRE FRICKE, BERLIN (DE); ERHARD PIPPERT, DALLGOW-DOEBERITZ OT SEEBURG (DE); DIRK SAGASSER, BERLIN (DE)

(21) Appl. No.: 15/042,373

(22) Filed: Feb. 12, 2016

(30) Foreign Application Priority Data
Feb. 12, 2015 (EP) 15154862.5

(51) Int. Cl. H01C 7/12; H01C 1/14

(52) U.S. Cl. CPC H01C 7/12; H01C 1/14

(57) ABSTRACT

An overvoltage arrester includes a column extending between first and second electrical terminals and having resistance elements being stacked on one another and having first and second opposite contact faces. The first and second contact faces of adjacent resistance elements adjoin one another. The column has a first group of resistance elements being directly connected by their first contact faces to the first electrical terminal and by their second contact faces to the second electrical terminal, and a second group of resistance elements being directly connected by their first contact faces to the second electrical terminal and by the second contact faces to the first electrical terminal. The result is a compact overvoltage arrester in which all of the resistance elements are connected electrically parallel with one another and which has a particularly high energy absorption capacity.

### CROSS-REFERENCE TO RELATED APPLICATION

This application claims the priority, under 35 U.S.C. §119, of European Patent Application EP 1 515 4862.5, filed Feb. 12, 2015; the prior application is herewith incorporated by reference in its entirety.

### BACKGROUND OF THE INVENTION

1. Field of the Invention

The invention relates to an overvoltage arrester having a column which extends between first and second electrical terminals and is composed of resistance elements being stacked one on top of the other and each having first and second oppositely disposed contact faces, in which the resistance elements are stacked in such a way that the first contact face of a resistance element adjoins the second contact face of an adjacent resistance element in the column.

Overvoltage arresters are protective systems, for example for power transmission grids. The protective systems conduct away to ground overvoltages occurring as a result of lightning strikes or malfunctions of other part systems, and thereby protect other components of the power transmission grid.

Such a voltage arrester includes one or more cylindrical arrester columns composed of resistance elements which are frequently constructed of individual, likewise cylindrical varistor elements. Varistors are defined by a voltage-dependent resistance. At low voltages, they act as insulators. Starting from a certain threshold voltage which is material-dependent, they exhibit a good level of conductivity. Frequently, varistors are manufactured from metal oxides such as zinc oxide. The arrester column is connected at both ends to end fittings which bring about the electrical connection to the power lead and to ground. In order to ensure good electrical contact even under mechanical loading, the arrester column has to be held together under pressure. That can be done in such a way that tensile strength elements, for example cables or rods, preferably made of glass-fiber-reinforced plastic, are clamped under tension in the end fittings or in pressure plates disposed at the ends of the arrester column. The tensile strength elements surround the arrester column in that case and in doing so form a cage around it. Starting from a certain size or, if the overvoltage arrester is to be set up in a region which is at risk of earthquakes, the arrester column is disposed in a mechanically stable, tubular housing made of an insulator material, for example made of porcelain or glass-fiber-reinforced plastic. The end fittings can then serve simultaneously as closures for the housing. Such overvoltage arresters frequently have a pressure-relief device in order to conduct away gases which are produced in the case of overloading from the housing.

European Patent Application EP 2 757 565 A1 presents such an overvoltage arrester in FIG. 1. In that figure, a column made of resistance elements is disposed in a tubular housing. The resistance elements are composed of individual cylindrical varistor elements which are stacked to form the column. As a result, the individual resistance elements are connected electrically in series with one another.

International Publication WO 94/14171 A1, corresponding to U.S. Pat. No. 5,596,476, also describes such an overvoltage arrester. In that case, a plurality of columns composed of resistance elements are disposed in a housing. The resistance elements of each column are also connected electrically in series with one another in that case. However, the columns are connected electrically parallel with one another. As a result, an increased energy absorption capacity is obtained, and/or the residual voltage is reduced.

In the case of other applications, such as the protection of capacitors which are used in high-voltage or medium-voltage power grids for reactive power compensation or as filters, overvoltage arresters with an even significantly higher energy absorption capacity and at the same time low residual voltage are required. The technology described in the abovementioned publication, with columns which are connected in parallel and are composed of resistance elements, is limited since the required housing dimensions increase with the number of columns which are required.

### SUMMARY OF THE INVENTION

It is accordingly an object of the invention to provide an overvoltage arrester, which overcomes the hereinafore-mentioned disadvantages of the heretofore-known devices of this general type, which is compact and which has a high energy absorption capacity.

With the foregoing and other objects in view there is provided, in accordance with the invention, an overvoltage arrester in which a column composed of resistance elements which are stacked one on top of the other extends between a first and a second electrical terminal. The resistance elements are generally cylindrical, often circular-cylindrical, blocks made of a material with a voltage-dependent resistance, referred to as varistor elements. The material used in this case is frequently a metal oxide, for example zinc oxide. A resistance element has at least one varistor element and can, in addition to the latter, also contain further elements such as, for example, spacer elements made of a material which is a good electrical conductor, such as steel or aluminum. In this context, just one of the resistance elements, or some of the resistance elements or all thereof, of the column, can have such spacer elements. The resistance elements are stacked one on top of the other to form the column by their end sides along a longitudinal column axis. The end sides serve in this case as first and second contact faces, lying opposite one another, of the resistance element. The resistance elements are stacked in the column in such a way that the first contact face of each resistance element points toward the first electrical terminal, and the second contact face points toward the second electrical terminal. In this context, the first contact face of a resistance element adjoins the second contact face of a resistance element which is adjacent thereto in the column. This can mean that the first contact face of the one resistance element bears against the second contact face of the adjacent resistance element, but also that a connecting element composed of a material which is a good electrical conductor is disposed between the two contact faces. In each case, the first contact face of the one resistance element and the second contact face of the adjacent resistance element are in direct electrical contact with one another, that is to say are connected directly to one another or at most to one another through a good electrical conductor, but not through active or passive electrical components such as resistors, coils, semiconductor components or the like. In each case, a contact face of two resistance elements lying at the outer ends in the column form the outer end faces of the column. An electrical connection which is disposed between these two outer end faces of the column runs through the column.

End fittings which serve as electrical terminals can be disposed at the ends of the column. Furthermore, tensile strength elements, which hold the column together, can be clamped in the end fittings. The end fittings are generally fabricated from a material which is a good electrical conductor. The tensile strength elements are, in contrast, composed of an electrically insulating material such as, for example, a glass-fiber-reinforced plastic.

According to the invention, the column has at least two groups of resistance elements. The resistance elements of the first group are each connected directly by their first contact face to the first electrical terminal and by their second contact face to the second electrical terminal. The resistance elements of the second group are each directly connected by their first contact face to the second electrical terminal and by their second contact face to the first electrical terminal. In this case, the phrase connected directly to the terminal means that the connection is produced through a good electrical conductor, for example made of copper, steel or aluminum, and no active or passive electrical components such as resistors, coils, semiconductor components or the like are connected into the current path between the respective contact face and the relevant electrical connection. The electrical connection can be produced, for example, by using cables. The electrical connection can be made either outside the column, in that the contact between two adjoining contact faces is led out of the column by using a connecting element between, in each case, two resistance elements. The connecting elements can be connected outside the column by customary measures such as cables. The electrical connection can also be made inside the column. This would require a continuous drilled hole which passes through each resistance element. The conductors which connect the respective contact faces to one another then run within the drilled hole.

The individual resistance elements are connected in parallel between the first and second electrical terminals by using these electrical connections. If the column is composed of n resistance elements, the equivalent circuit is a parallel circuit composed of n resistance elements. The current flowing through this circuit is therefore n-times an individual column, insofar as component tolerances are not taken into account.

Resistance elements of the first group and resistance elements of the second group preferably alternate with one another in the column. As a result, each of the contact faces of the first and second groups of resistance elements which are connected to the first electrical terminal adjoin one another within the column. The same applies to the contact faces which are connected to the second electrical terminal. For example, any resistance element of the first group within the column, given the preferred alternating configuration the resistance element, lies between two resistance elements of the second group. In this context, in each case the first contact face of the resistance elements of the first group adjoins the second contact face of a resistance element of the second group. As a result, both contact faces can be connected to the first electrical terminal in a particularly easy way. For example, this is by virtue of the fact that a connecting element disposed between the two contact faces conducts the electrical connection to outside the column and is connected there to the first electrical terminal.

This resistance element of the first group adjoins, with its second contact face, a first contact face of a resistance element of the second group. The connection between these two contact faces on the second electrical terminal can be brought about in an equivalent way to that described above.

In one preferred refinement of the invention, first and second contact plates are disposed between adjacent resistance elements in the column. Therefore, in each case, one contact plate, which is either a first or a second contact plate, is disposed between two adjoining contact faces of two resistance elements. Therefore, a first contact plate is respectively disposed between a first contact face of a resistance element of the first group and the second contact face of a resistance element of the second group, and a second contact plate is respectively disposed between the second contact face of a resistance element of the first group and the first contact face of a resistance element of the second group. Both first and second contact plates therefore lie between two resistance elements in each case and connect the two adjoining contact faces to one another electrically. The contact plates are good electrical conductors and are preferably manufactured from aluminum or steel.

There is therefore an electrical connection running through the column from the first contact face of the first resistance element to the second contact face of the last resistance element of the column.

All of the contact plates have a contact lug lying outside the column. The contact lugs of the first contact plates are electrically connected to one another in this case, and the contact lugs of the second contact plates are also electrically connected to one another. An electrical connection to two contact faces can therefore lead in a particularly simple way to outside the column and be connected to one another there.

The contact lugs of the first contact plates and the contact lugs of the second contact plates are in each case particularly preferably aligned with one another. As a result, the contact lugs of the first contact plates lie on a first contact axis parallel to the longitudinal arrester axis of the overvoltage arrester. The contact lugs of the second contact plates lie on a second contact axis, also parallel to the longitudinal arrester axis. The first and second contact axes are at a minimum distance from one another in this case, that is to say are not congruent. The first and second contact axes preferably lie opposite one another with respect to the longitudinal arrester axis. The contact lugs of the first group are connected to one another in this case by using a connecting conductor. The contact lugs of the second contact plates are also connected to one another by using a further connecting conductor. As a result, a particularly simple and space-saving connection of the resistance elements to one another can be brought about.

The connecting conductor can, for example, in each case be a cable which is connected to the contact lugs with commercially available cable clamps. A further exemplary embodiment of a connecting conductor is in each case a threaded rod made of metal which is guided through holes in the contact lugs and connects to the contact lugs by using nuts. In this way, one threaded rod would connect all of the contact lugs of the first contact plates to one another, and a second threaded rod would connect all of the contact lugs of the second contact plates.

The first and second contact plates are particularly preferably disposed congruently with respect to one another. The first and second contact plates are then rotated with respect to one another in the column, with the result that the contact lugs of the first and second contact plates lie on different axes one on top of the other. As a result, identical parts can be used for first and second contact plates, which is advantageous in terms of logistics.

In one advantageous refinement of the invention, at least two columns which are parallel with one another extend between the first electrical terminal and the second electrical terminal. In this context, a contact plate which extends over all of the columns and connects them electrically to one another electrically is disposed between each resistance element. If a large number of resistance elements is required, as a result they can be distributed among a plurality of columns and therefore disposed in a particularly space-saving fashion.

In a further advantageous refinement of the invention, the column, but particularly preferably a plurality of columns, is/are disposed in a tubular housing which is closed off in a fluid-tight fashion and has a first and a second fitting element. In this context, the first fitting element is connected to the first electrical terminal, and the second fitting element is connected to the second electrical terminal. The resistance elements are protected against the influences of the weather by the housing. The housing can have in this case a tubular casing made of a nonconductive material such as porcelain or glass-fiber-reinforced plastic. The fitting elements made of metal can serve in this case as flanges which close the housing and bring about the electrical connection to the resistance elements, on one hand, and to a component to be protected, on the other hand. The housing can, however, also be a pressure-tight housing made of metal for use in a gas-insulated switching system. In this context, the fitting elements would be bushings which conduct an electrical connection of the resistance elements from the housing to the outside in an electrically insulated fashion.

In this context, the column, or in the case of a plurality of columns each of the columns, preferably has an uneven number of resistance elements. This permits particularly simple electrical connection of the fitting elements, since one of the contact faces which then lies entirely on the outside is then connected to the first electrical terminal, and the other to the second electrical terminal.

Other features which are considered as characteristic for the invention are set forth in the appended claims.

Although the invention is illustrated and described herein as embodied in an overvoltage arrester, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIGS. 1 to 3 are schematic and block diagrams illustrating different embodiments of an overvoltage arrester according to the invention;

FIG. 4 is a schematic and block diagram of an equivalent circuit of an overvoltage arrester according to the invention;

FIG. 5 is a diagrammatic, perspective view of an example of an overvoltage arrester according to the invention with one column;

FIG. 6 is an exploded perspective view of the overvoltage arrester of FIG. 5;

FIG. 7 is a perspective view of an example of an overvoltage arrester according to the invention with two columns;

FIG. 8 is a plan view of a contact plate of the overvoltage arrester of FIG. 7;

FIG. 9 is a longitudinal-sectional view of an overvoltage arrester with four columns; and

FIG. 10 is a fragmentary, longitudinal-sectional view of the overvoltage arrester of FIG. 9.

### DETAILED DESCRIPTION OF THE INVENTION

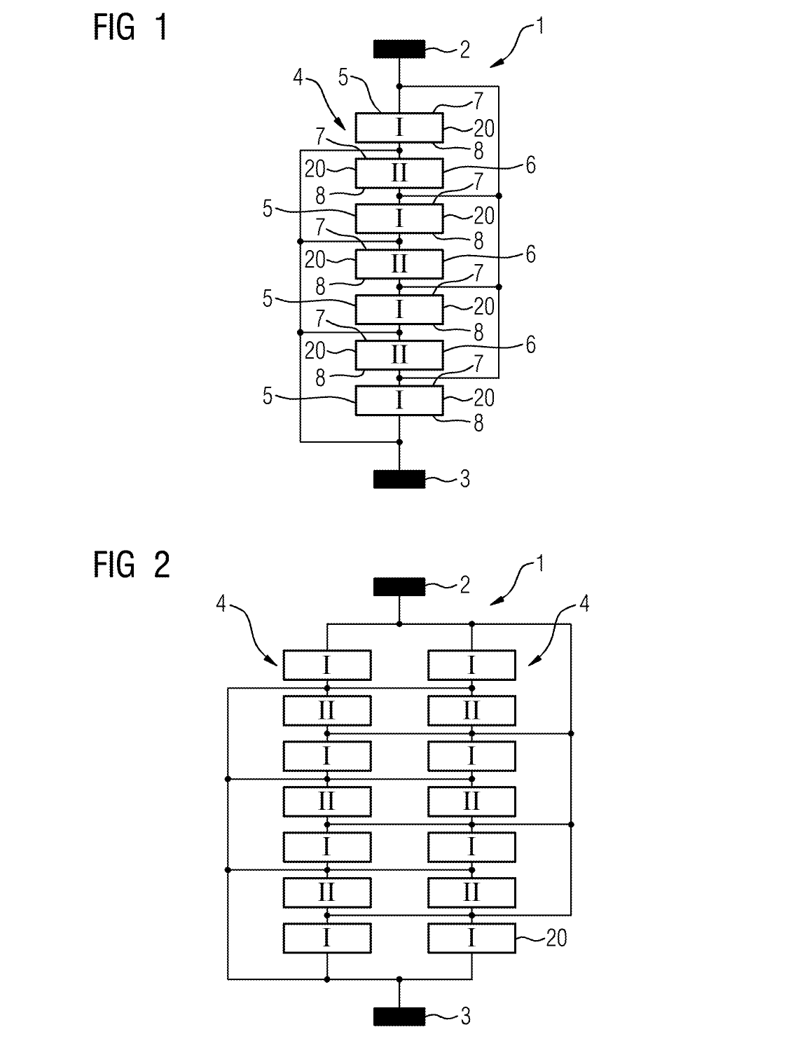

Referring now in detail to the figures of the drawings, in which components that correspond to one another are provided with the same reference symbols throughout, and first, particularly, to FIGS. 1-3 thereof, there are seen schematic and block illustrations of different embodiments of an overvoltage arrester 1 according to the invention. These figures are intended mainly to explain the electrical connection of the individual elements. The physical configuration of the individual elements is only schematically illustrated. FIG. 1 shows an overvoltage arrester 1. A column 4 composed of seven resistance elements 20 extends between a first electrical terminal 2 and a second electrical terminal 3. The number seven is randomly selected in this case. The invention relates to overvoltage arresters 1 with at least two resistance elements 20. A preferred embodiment in this case is a column with an uneven number of resistance elements, but the invention is not restricted thereto. The resistance elements 20 are cylindrical, preferably circular-cylindrical. The end faces of a resistance element 20 form first and second contact faces 7, 8. The resistance elements 20 are disposed in the column in this case in such a way that the first contact faces 7 of all of the resistance elements 20 point to the first electrical terminal 2, and the second contact faces 8 of all of the resistance elements 20 point to the second electrical terminal 3. Therefore, at every location at which two resistance elements adjoin one another, a first contact face 7 of a resistance element 20 adjoins a second contact face 8 of an adjacent resistance element 20. The first and second electrical terminals 2, 3 can, for example, be end fittings which bound the column 4 on both sides. Within the column 4, the resistance elements 20 are disposed in two groups, that is a first group 5 and a second group 6. The resistance elements 20 which are denoted by I belong to the first group 5, and those which are denoted by II belong to the second group 6. This is also the case in the following figures, even if the reference symbols 5 and 6 have been omitted for reasons of clarity. The resistance elements 20 of the first group 5 are all connected directly by their first contact faces 7 to the first electrical terminal 2, and by their second contact faces 8 to the second electrical terminal 3. The direct connection is an electrical connection which is composed of a good electrical conductor such as copper, steel, aluminum or other electrically conductive metals or else of hydrocarbon fibers.

FIG. 2 shows an overvoltage arrester 1, in which two columns 4 with, in each case, seven resistance elements 20, are disposed between the first and second electrical terminals 2, 3. The columns 4 are connected to one another at every location at which two resistance elements 20 adjoin one another.

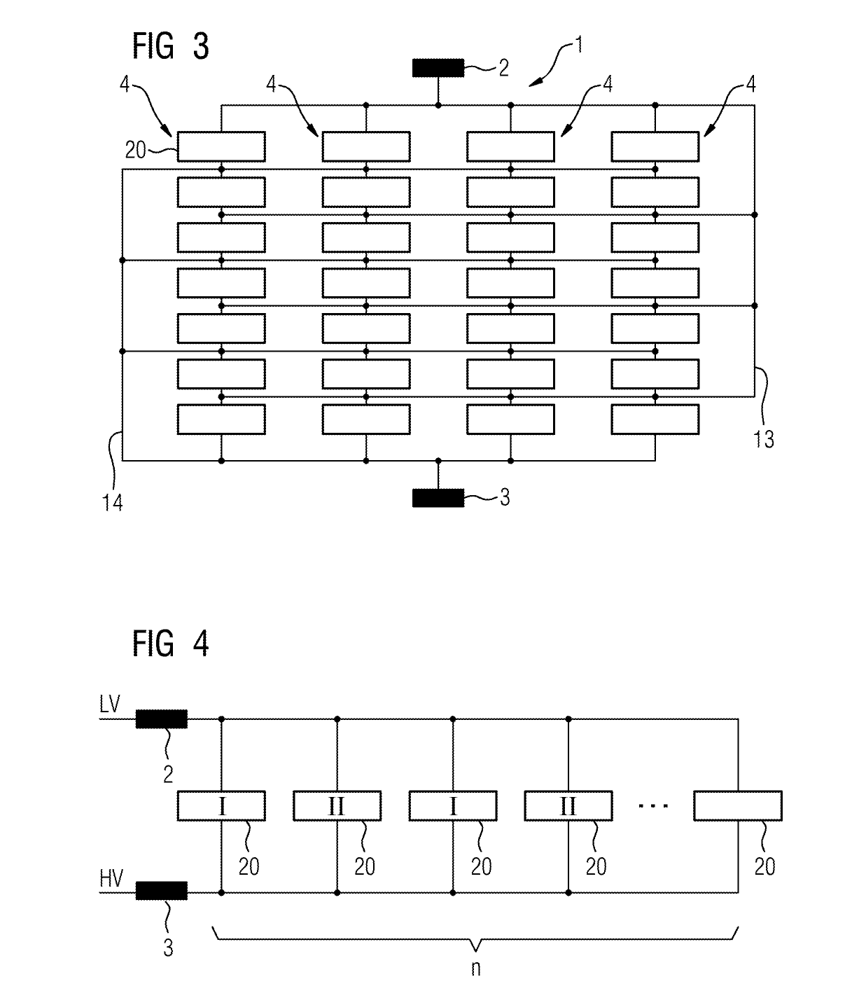

FIG. 3 shows an overvoltage arrester 1 with four columns 4 with in each case seven resistance elements 20. In this case, all of the columns 4 are connected to one another at each location at which two resistance elements 20 adjoin one another.

FIG. 4 shows a general equivalent circuit diagram with n resistance elements 20 which are all connected in parallel with one another between the first electrical terminal 2 and the second electrical terminal 3. For the connection according to FIG. 1, n=7, for the connection of FIG. 2, n=2.7=14, and finally of FIG. 4 n=4.7=28. All of the embodiments have in common the fact that all of the resistance elements 20 of the respective overvoltage arrester 1 are connected in parallel with one another between the first electrical terminal 2 and the second electrical terminal 3. Since each of the n resistance elements 20 therefore provides a separate current path independent from the others, the current which can be conducted through in the case of n resistance elements which are connected in parallel is a multiple, and if component tolerances are ignored, it is precisely a multiple of n times, of that through a column composed of n resistance elements which are connected in series with one another, and so the energy absorption capacity also increases correspondingly.

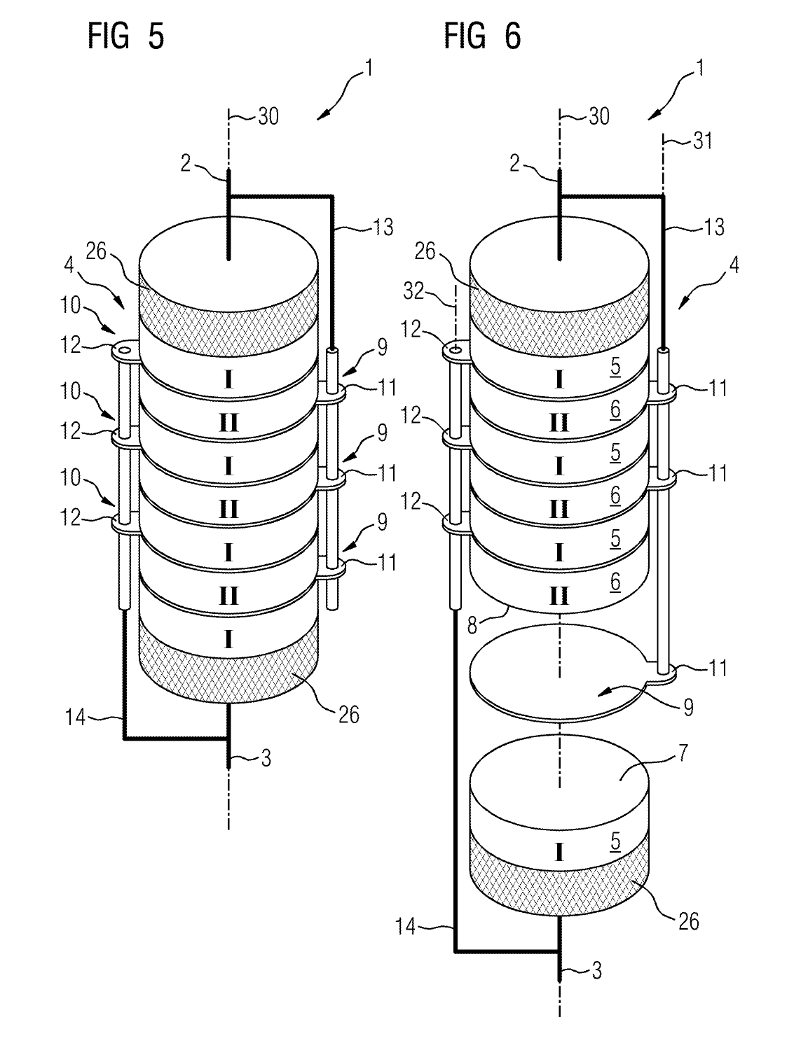

FIG. 5 shows an overvoltage arrester 1 with seven resistance elements which are disposed between the first electrical terminal 2 and the second electrical terminal 3 in a column 4. The resistance elements 20 are oriented in such a way that all of the first contact faces 7 point to the first electrical terminal 2, and all of the second contact faces point to the second electrical terminal 3.

FIG. 6 shows the same overvoltage arrester 1, wherein the column 4 between two resistance elements 20 is illustrated in an exploded view. In both cases, seven resistance elements 20 are stacked to form one column. The resistance elements 20 of the first group 5 are denoted in this case again by reference symbol I, and those of the second group by reference symbol II. In the illustrated embodiment, resistance elements 20 of the first group 5 and those of the second group 6 alternate. Since the column 4 is constructed in this case from an uneven number of resistance elements 20, the column 4 is bounded at both ends by resistance elements 20 of the first group 5. End fittings 26, which serve at the same time as electrical terminals 2, 3, are disposed at both ends of the column 4. The end fittings can have connection elements (not illustrated herein) through which they can be connected to an electrical system. For example, the end fitting 26 which is the upper one in FIGS. 5 and 6 is connected to a high voltage terminal and the lower end fitting 26 is connected to the ground terminal of an electrical system. The first electrical terminal 2 is then connected to high voltage, and the second electrical terminal 3 to ground. The end fittings 26 are made of a material which is a good electrical conductor, such as a metal, and bring about the electrical connection between the column 4 and the electrical system.

In the column 4, first and second contact plates 9, 10 are disposed in an alternating fashion between two resistance elements 20 in each case. In FIG. 6, a contact plate 9 is visibly illustrated. The contact plates 10 appear to be of the same type but are rotated about 180° along the longitudinal column axis 30 of the column 4. The contact plates 9, 10 are circular disks in this case. The shape corresponds substantially to the cross section of the resistance elements 20. A contact lug 11, 12 is disposed at the edge of each contact plate 9, 10. The contact lug 11, 12 projects out of the lateral face of the column 4. Each contact plate 9, 10 is disposed between a first and a second contact face 7, 8, of two resistance elements 20, and brings about the electrical contact between these two contact faces 7, 8. The first contact plates 9 are disposed in such a way that the contact lugs 11 thereof are aligned with one another, that is to say they lie on a first alignment axis 31, parallel to the longitudinal column axis 30. The second contact plates 10 are disposed in such a way that their contact lugs 12 are aligned with one another on a second alignment axis 32. The first and second alignment axes 31, 32 lie, in the present example, on opposite sides, with respect to the longitudinal column axis 30. This is not absolutely necessary. Instead, the alignment axes 31, 32 can also lie one next to the other insofar as the necessary insulation distance is maintained. The contact lugs 11, 12 which are respectively aligned with one another are connected electrically to one another outside the column 4. All of the contact lugs 11 of the first contact plates 9 are connected to one another and to the first electrical terminal 2. All the contact lugs 12 of the second contact plates 10 are connected to one another and to the second electrical terminal 3. The connection of the contact lugs 11, 12 to one another and to the respective electrical terminal 2, 3 can be made, for example, by using cables. These connections are only schematically illustrated herein. The overvoltage arrester 1 which is illustrated in FIGS. 5 and 6 can be disposed in a housing which is not illustrated therein.

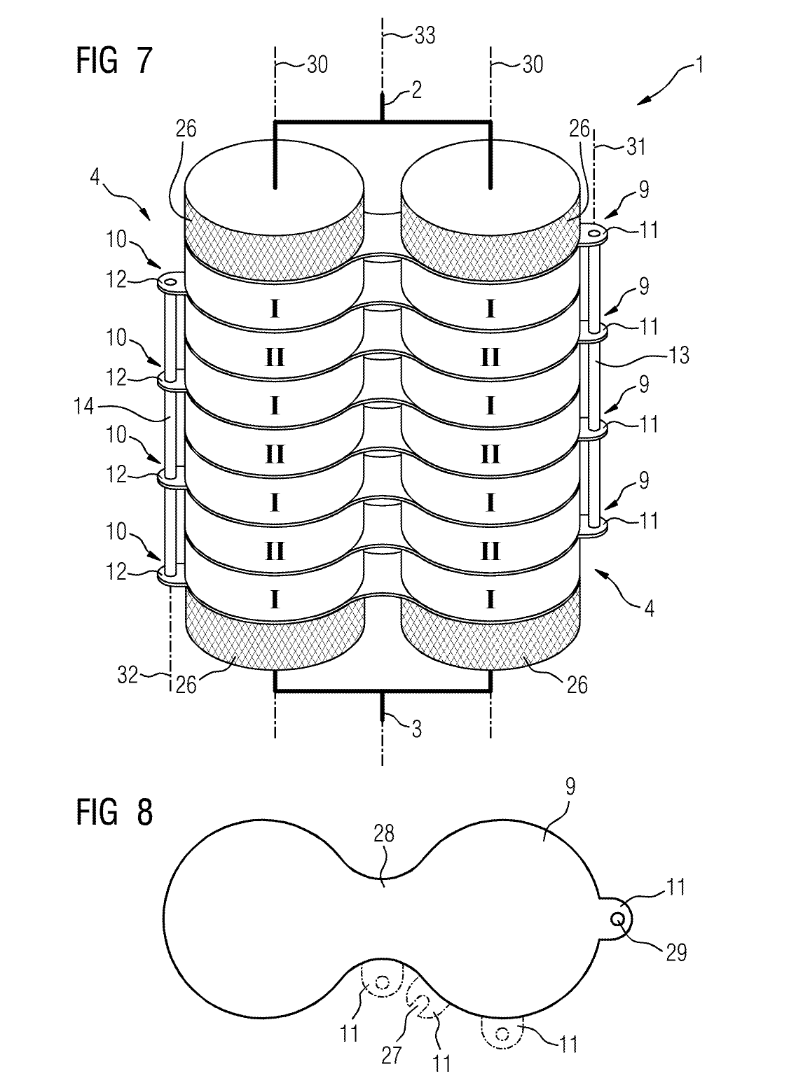

FIG. 7 shows an overvoltage arrester 1 with two parallel columns 4, each with seven resistance elements 20. The longitudinal axes 30 of the column are parallel to one another and to the longitudinal arrester axis 33. Each column 4 is disposed between two end fittings 26. The two end fittings which lie at the upper end of the columns 4 together form the first electrical terminal 2, and the two end fittings 26 which lie at the lower end of the columns 4 together form the second electrical terminal 3. The configuration and orientation of the resistance elements 20 of the two columns 4 is as shown in FIGS. 5 and 6. First and second contact plates 9, 10 are disposed in each case between two resistance elements 20 in this case. The contact plates 9, 10 each extend over both columns 4 and connect them to one another electrically. In contrast to FIGS. 5 and 6, contact plates 9, 10 are also disposed between the resistance elements 20, bounding the column 4, and the adjoining end fitting 26. This can facilitate the electrical connection of the two end fittings 26 which are parallel to one another. The electrical connection can, however, also alternatively be made on the outside of the two end fittings 26.

FIG. 8 illustrates such a contact plate 9. The contact plate 10 is congruent therewith. The contact plates 9, 10 are composed of two circular disks which are connected to one another by a connecting web 28. A contact lug 11, 12, which protrudes out of the lateral face of the column 4, is disposed at the edge of each contact plate 9, 10. A plurality of possible positions and shapes of contact lugs 11, 12 are illustrated by broken lines in FIG. 8. A particularly space-saving variant is a contact lug 11 in the vicinity of the connecting web 28, that is to say at the interstice between the two columns 4. The contact lugs 11, 12 can have drilled holes 29 or elongate holes 27 into which a connecting conductor 13, 14 is introduced in order to bring about the electrical connection. This connecting conductor 13, 14 can, for example, be a cable or a rod made of metal.

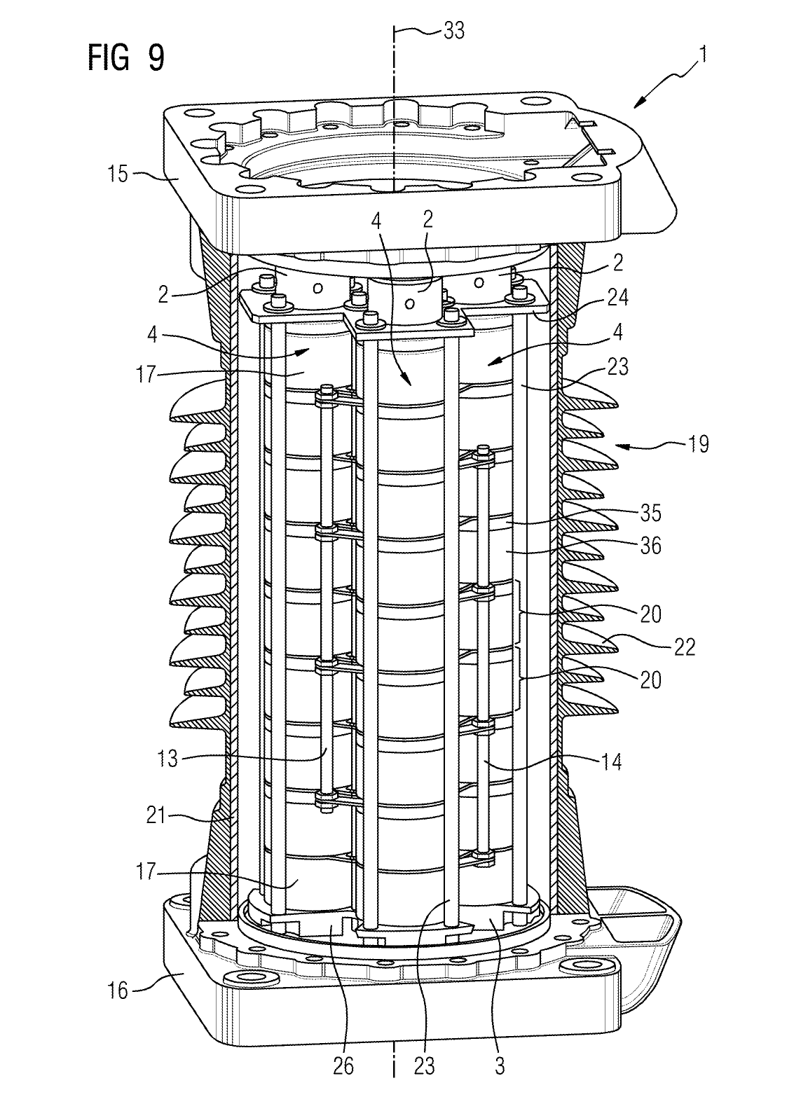

FIG. 9 shows a sectional illustration of an overvoltage arrester 1 in which four columns 4, each with seven resistance elements, are disposed between the first electrical terminal 2 and the second electrical terminal 3. The columns 4 are disposed in a housing 19. The housing 19 can, as illustrated, be composed of a housing tube 21 made of an electrically insulating material such as glass-fiber-reinforced plastic or porcelain, and can have an outer sheath, for example silicone, on the outside in order to protect against weather conditions. The outer sheath frequently has shields 22 for extending the creepage path. The housing 19 is closed off at both ends in a fluid-tight fashion by first and second fitting elements 15, 16. The fitting elements 15, 16 are made of an electrically conductive material such as a metal and provide, on one hand, a connection to the columns 4 inside the housing 19 and, on the other hand, a connection to an electrical system from outside the housing 19.

The columns 4 are disposed between a tension plate 24 and an end fitting 26, which serves at the same time as a second electrical terminal 3. Tensile strength elements 23 which are clamped between the tension plate 24 and the end fitting 26 hold the columns 4 together. The tension plate 24 can be manufactured from an electrically insulating material such as glass-fiber-reinforced plastic or from an electrically conducting material such as metal. In the first case, the tension plate has holes through which the electrical connection to the columns 4 is made.

Each column 4 has seven resistance elements 20, which are each composed in this case of a varistor element 35 and a spacer element 36. The spacer elements 36 are bodies made of metal which are good electrical conductors and serve, on one hand, to facilitate mounting of the connecting conductor 13, 14 and, on the other hand, to adapt the length of the column to the size of the housing. Furthermore, the spacer elements 36 enlarge the surface of the resistance elements 20, as a result of which they can be cooled better. Each resistance element 20 has, at least, one varistor element 35, and some or all of the resistance elements 20 can have spacer elements 36. In each case, filler pieces 17, which serve to equalize lengths, are disposed at the ends of the columns. The filler pieces 17 are also made of metal and connect the resistance elements to the first and second electrical terminals 2, 3. Metal cylinders, which are disposed between the first fitting element 15 and the columns 4 and which bring about the electrical connection between the latter, if appropriate through the tension plate 24, serve in this case as the first electrical terminal 2. The second electrical terminal 3 is made available by the end fitting 26 which is electrically connected, as a cross-shaped plate made of metal, to the second fitting element 16 and attached thereto.

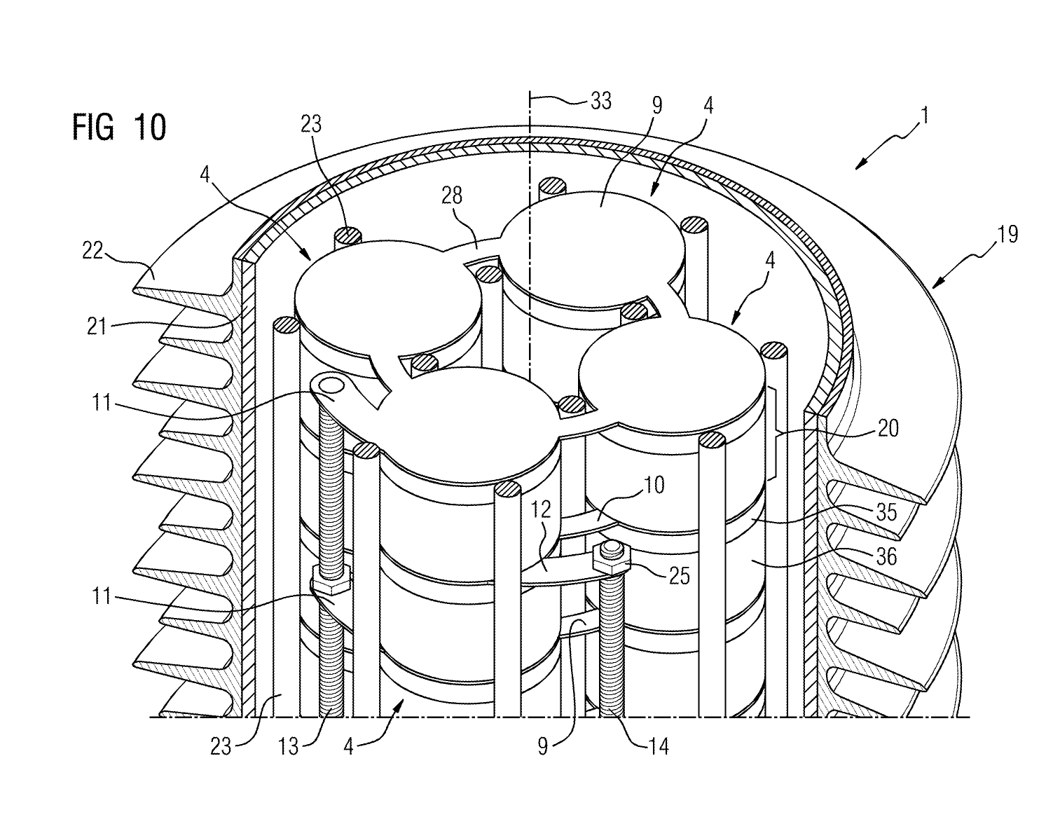

FIG. 10 shows a further illustration of the overvoltage arrester 1 of FIG. 9. In this case, the internal structure of the columns 4 is illustrated by using an additional section. A first or a second contact plate 9, 10 is disposed between each two resistance elements 20. Each of the contact plates 9, 10 is composed of four circular disks, one for each column 4, which disks are connected to one another with connecting webs 28 in a square. The contact plates 9, 10 therefore connect the columns 4 to one another electrically. The contact plates 9, 10 have contact lugs 11, 12 in the form of tongues. An additional contact plate 9, 10 is disposed between the respectively outermost resistance element 20 and a filler piece 17. All of the contact lugs 11 of the first contact plates 9 are aligned with one another and are connected to one another by using a connecting conductor 13, which is illustrated herein in the form of a threaded rod. Likewise, all of the contact lugs 12 of the second contact plates 10 are aligned with one another and are connected to one another by using a connecting conductor 14, also in the form of a threaded rod. The electrical connection to the first or second electrical terminal 2, 3 is brought about by the filler pieces 17. The connecting conductors 13, 14 are guided through drilled holes 29 in the contact lugs 11, 12 and attached thereto by using nuts 25.

1. An overvoltage arrester, comprising:
first and second electrical terminals;
a column extending between said first and second electrical terminals, said column being composed of resistance elements each having first and second mutually opposite contact faces;
said resistance elements being stacked on top of one other with said first contact face of one resistance element adjoining said second contact face of an adjacent resistance element in said column;
said resistance elements of said column being disposed in first and second groups;
said first contact face of said resistance elements of said first group being directly connected to said first electrical terminal and said second contact face of said resistance elements of said first group being directly connected to said second electrical terminal; and
said first contact face of said resistance elements of said second group being directly connected to said second electrical terminal and said second contact face of said resistance elements of said second group being directly connected to said first electrical terminal.

2. The overvoltage arrester according to claim 1, wherein said resistance elements of said first group and said resistance elements of said second group are alternately disposed in said column.

3. The overvoltage arrester according to claim 1, which further comprises:
first and second contact plates disposed between adjacent resistance elements in said column;
said first contact plates each being disposed between said first contact face of a respective one of said resistance elements of said first group and said second contact face of a respective one of said resistance elements of said second group;
said second contact plates each being disposed between said second contact face of a respective one of said resistance elements of said first group and said first contact face of a respective one of said resistance elements of said second group;
each of said contact plates having a contact lug lying outside said column; and
said contact lugs of said first contact plates being connected to one another and said contact lugs of said second contact plates being connected to one another.

4. The overvoltage arrester according to claim 3, wherein said first and second contact plates are disposed congruently with respect to one another.

5. The overvoltage arrester according to claim 3, which further comprises:
connecting conductors made of electrically conductive material;
said contact lugs of said first contact plates being aligned with one another and connected to one another by one of said connecting conductors; and
said contact lugs of said second contact plates being aligned with one another and connected to one another by another of said connecting conductors.

6. The overvoltage arrester according to claim 3, wherein:
said column is one of at least two mutually parallel columns extending between said first and second electrical terminals;
said contact plates disposed between adjacent resistance elements extend over all of said columns and electrically connect said contact plates to one another.

7. The overvoltage arrester according to claim 3, which further comprises:
a tubular housing in which said column is disposed;
said tubular housing being closed off in a fluid-tight manner and having first and second fitting elements;
said first fitting element being connected to said first electrical terminal and said second fitting element being connected to said second electrical terminal.
